(19) United States
(12) Patent Application Publication
(10) Pub. No.: US 2014/0206583 A1
(43) Pub. Date: Jul. 24, 2014

(54) WELLBORE SERVICING FLUID HAVING HYDROPHOBICALLY MODIFIED POLYMERS

(71) Applicants: Roger L. Kuhlman, Lake Jackson, TX (US); Michael Poindexter, Sugar Land, TX (US); Cole Witham, Pearland, TX (US)

(72) Inventors: Roger L. Kuhlman, Lake Jackson, TX (US); Michael Poindexter, Sugar Land, TX (US); Cole Witham, Pearland, TX (US)

(73) Assignee: DOW Global Technologies LLC, Midland, MI (US)

(21) Appl. No.: 14/342,992

(22) PCT Filed: Sep. 6, 2012
(86) PCT No.: PCT/US2012/053928

§ 371 Date: Mar. 5, 2014

Related U.S. Application Data
(60) Provisional application No. 61/531,824, filed on Sep. 7, 2011.

(51) Int. Cl. C09K 8/588

(52) U.S. Cl. CPC C09K 8/588
USPC 507/216

(57) ABSTRACT

Embodiments of the present disclosure include a wellbore servicing fluid that includes a diluent, a hydrophobically modified polymer, and a base. The base provides the wellbore servicing fluid with a pH of greater than 10. The presence of the base in the wellbore servicing fluid helps to minimize changes in the viscosity of the wellbore servicing fluid when a deposit, or a kick, of salt is encountered during the drilling operation.

### FIELD OF DISCLOSURE

This disclosure relates to a wellbore servicing fluid and in particular to a wellbore servicing fluid that includes a hydrophobically modified polymer.

### BACKGROUND

The process of oil, gas and/or water recovery can be divided into three stages, the drilling stage, the completion stage, and the workover stage. During the drilling stage, a drill rig is used to turn a drill bit that penetrates the surface of the earth to create a wellbore, which reaches the area that has concentrations of oil, gas, and/or water. The completion stage consists of preparing the wellbore for the flow of oil, gas and/or water and consists of for example, placing a metal casing into the wellbore to maintain the integrity of the wellbore and then cementing the casing in place. The workover stage is often performed on older wells and consists of performing maintenance on the wellbore to increase the flow of oil, gas and/or water from the well.

During the process of oil, gas and/or water recovery, all of the above stages employ a variety of fluids. These fluids are often referred to as wellbore servicing fluids and fulfill various purposes. For example, one purpose that the wellbore servicing fluid can fulfill in the drilling stage is helping with the removal of drilling particles, also known as cuttings, that have been created by the drill bit contacting the earth as the wellbore is being created. To remove the cuttings, the wellbore servicing fluid is pumped under pressure down the center of a string of drilling pipes and through the drill bit located at the bottom of the wellbore as the hole is being created. The wellbore servicing fluid then returns to the surface while carrying the cuttings through the space between the drilling pipes and the sides of the wellbore. Therefore, one property that becomes important in the wellbore servicing fluid for the drilling stage is its ability to suspend cuttings in the fluid. This property is important because the particles would not reach the surface if the fluid could not suspend them as it travels upward. Furthermore, this property is important because if the flow of the wellbore servicing fluid were to stop, the particles would settle out in the wellbore if not suspended. This is particularly true for deviated or horizontal wells where there is less distance for solids to travel before settling out.

One way to obtain this property of the wellbore servicing fluid is by modulating the rheological properties of the wellbore servicing fluid, such as viscosity. Sometimes, however, challenges arise when trying to modulate the viscosity because the chemical compounds that form the wellbore servicing fluid are not always compatible with one another. In more recent years, attention has been directed to changing the viscosity of wellbore servicing fluids by the addition of polymers. The polymers can dissolve in the fluid and help to modulate the viscosity, making the wellbore servicing fluid more suitable for the various stages of the oil, gas and/or water recovery process. Polymers can prove especially effective in modulating viscosity when they are compatible with the various other components of the wellbore servicing fluid and are able to dissolve within the fluid. However, when the polymers are not compatible with the various other components of the wellbore servicing fluid and do not dissolve, they prove ineffective in modulating viscosity. Therefore, it is desirable to improve the compatibility of certain polymers with certain wellbore servicing fluid components.

### SUMMARY

Embodiments of the present disclosure include a wellbore servicing fluid that includes a diluent, a hydrophobically modified polymer, and an amount of a base, where the amount of the base adjusts the pH of the wellbore servicing fluid to greater than 10. The amount of the base adjusts the pH of the wellbore servicing fluid to greater than 10 thereby providing a viscosity that decreases no more than 33 percent of a change of viscosity in a control solution, each measured at 30° C. according to the methods provided herein, when a predefined concentration of salt is present in each of the control solution and the wellbore servicing fluid. The control solution is defined herein.

Other changes in the viscosity of the wellbore servicing fluid are also possible. For example, the amount of the base adjusts the pH of the wellbore servicing fluid to greater than 10 thereby providing a viscosity that decreases no more than 74 percent of a change of viscosity in a control solution, each measured at 30° C. according to the methods provided herein, when a predefined concentration of salt is present in each of the control solution and the wellbore servicing fluid. In an additional example, the amount of the base adjusts the pH of the wellbore servicing fluid to greater than 10 thereby providing a viscosity that decreases no more than 86 percent of a change of viscosity in a control solution, each measured at 30° C. according to the methods provided herein, when a predefined concentration of salt is present in each of the control solution and the wellbore servicing fluid. In a further example, the amount of the base adjusts the pH of the wellbore servicing fluid to greater than 10 thereby providing a viscosity that decreases no more than 91 percent of a change of viscosity in a control solution, each measured at 30° C. according to the methods provided herein, when a predefined concentration of salt is present in each of the control solution and the wellbore servicing fluid.

The hydrophobically modified polymer can be a hydrophobically modified polysaccharide. For example, the hydrophobically modified polysaccharide can be a hydrophobically modified hydroxyethyl cellulose. The base can be an inorganic base selected from the group consisting of sodium hydroxide, potassium hydroxide, ammonium hydroxide, calcium hydroxide and combinations thereof. The predefined concentration of salt that is present and that creates the change in viscosity in each of the control solution and the wellbore servicing fluid has a saturation concentration of more than fifty percent. The salt includes a monovalent salt. Examples of such a salt include sodium chloride, potassium chloride or a combination thereof.

The present disclosure further includes a method of minimizing a change in a viscosity of a wellbore servicing fluid when a salt mixes with the wellbore servicing fluid. The method includes providing an admixture of a diluent and a hydrophobically modified polymer; and adding a base to the admixture to adjust a pH of the wellbore servicing fluid to greater than 10 to provide a viscosity of the wellbore servicing fluid sufficient to maintain drilling operations when the salt is present in the wellbore servicing fluid. For example, adding the base provides the wellbore servicing fluid with a viscosity, measured at 30° C. according to the methods provided herein, which decreases no more than 33 percent of a change of viscosity in the control solution (as defined herein), measured at 30° C. according to the methods provided herein, when a predefined concentration of the salt is present in each of the control solution and the wellbore servicing fluid. The base can be added such that the pH is adjusted to at least 11. The base can be added such that the pH is adjusted to at least 12. The base can also be used in adjusting the pH of the wellbore servicing fluid containing the salt to a value of greater than 10 to increase the viscosity of the wellbore servicing fluid to a value greater than the viscosity at the pH of 10.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE FIGURES

FIG. 1 provides viscosity versus temperature data for solutions of a hydrophobically modified polymer, the hydrophobically modified polymer with sodium chloride, the hydrophobically modified polymer with sodium hydroxide and embodiments of the wellbore servicing fluid of the present disclosure at a pH of 12.5 and a pH of 13 that includes the hydrophobically modified polymer, sodium chloride and sodium hydroxide.

FIG. 2 provides viscosity versus temperature data for solutions of a hydrophobically modified polymer, the hydrophobically modified polymer with potassium chloride, the hydrophobically modified polymer with potassium hydroxide and an embodiment of the wellbore servicing fluid of the present disclosure at a pH of 13 and a pH of 13.7, that includes the hydrophobically modified polymer, potassium chloride and potassium hydroxide.

FIG. 3 provides viscosity versus temperature data for solutions of a hydrophobically modified polymer, the hydrophobically modified polymer with sodium chloride, the hydrophobically modified polymer with sodium hydroxide and an embodiment of the wellbore servicing fluid of the present disclosure at a pH of 12.5 and a pH of 13, that includes the hydrophobically modified polymer, sodium chloride and sodium hydroxide.

FIG. 4 provides viscosity versus temperature data for solutions of a hydrophobically modified polymer, the hydrophobically modified polymer with potassium chloride, the hydrophobically modified polymer with potassium hydroxide and an embodiment of the wellbore servicing fluid of the present disclosure at a pH of 13 and a pH of 13.7, that includes the hydrophobically modified polymer, potassium chloride and potassium hydroxide.

### DEFINITIONS

As used herein, the terms “a,” “an,” “the,” “one or more,” and “at least one” are used interchangeably and include plural referents unless the context clearly dictates otherwise.

Unless defined otherwise, all scientific and technical terms are understood to have the same meaning as commonly used in the art to which they pertain. For the purpose of the present disclosure, additional specific terms are defined throughout.

The terms “comprises,” “includes” and variations of these words do not have a limiting meaning where these terms appear in the description and claims. Thus, for example, a process that comprises “a” salt can be interpreted to mean a process that includes “one or more” salts. In addition, the term “comprising,” which is synonymous with “including” or “containing,” is inclusive, open-ended, and does not exclude additional unrecited elements or method steps.

As used herein, “° C.” refers to degrees Celsius.

As used herein, the term “and/or” means one, more than one, or all of the listed elements.

The recitation of numerical ranges by endpoints includes all numbers subsumed within that range (e.g., 1 to 5 includes 1, 1.5, 2, 2.75, 3, 3.80, 4, 5, etc.).

As used herein, the term “diluent” can include, for example, water, a connate water, surface water, distilled water, carbonated water, sea water, water-based mud, a brine, and a combination thereof. For brevity, the word “diluent” will be used herein, where it is understood that one or more of “water,” “connate water,” “surface water,” “distilled water,” “carbonated water,” “sea water,” “brine” and/or “water-based mud” can be used interchangeably.

As used herein, the term “saturation” refers to a state of the wellbore servicing fluid where it holds the maximum equilibrium quantity of a salt at a given temperature.

As used herein, the term “molar substitution” refers to an ethylene oxide molar substitution (EO MS) of a polymer and is determined either by mass gain or using the Morgan modification of the Ziesel method: P. W. Morgan, Ind. Eng. Chem., Anal. Ed., 18, 500-504 (1946). The procedure is also described in ASTM method D-2364 (2007).

As used herein, the term “degree of substitution” refers to an average number of moles of the hydrophobic substituent(s) per mole of anhydroglucose unit and is designated as hydrophobe degree of substitution (hydrophobe DS). The hydrophobe DS is measured using the Morgan modification of the Zeisel method as described above, but using a gas chromatograph to measure the concentration of cleaved alkyl groups.

As used herein, “soluble” refers to the susceptibility of a substance to be dissolved in a liquid.

As used herein, the term “shale stabilizer-inhibitor” refers to an additive that prevents and/or retards the wellbore servicing fluid from hydrating, swelling, and/or disintegrating the materials, such as clay and/or shale formations, that are being drilled through.

As used herein, “rheological properties” refer to, but are not limited to one or more properties that relate to the flow of matter, such as the flow of the wellbore servicing fluid, where such properties include: viscosity, elasticity, gel strength, yield stress, storage modulus, and/or elastic modulus.

As used herein, a “control solution” is defined as an admixture of a diluent, a hydrophobically modified polymer. The control solution does not contain the base (e.g., base is not added to the admixture).

As used herein, “salt” refers to a neutral ionic compound obtainable by chemical combination of acid and base.

### DETAILED DESCRIPTION

The present disclosure provides a wellbore servicing fluid that includes a diluent, a hydrophobically modified polymer, and an amount of a base. The amount of the base adjusts a pH of the wellbore servicing fluid to greater than 10. The amount of the base also serves to provide the wellbore servicing fluid with a viscosity, as measured at 30° C. according to the methods provided herein, sufficient to maintain drilling operations when a salt is present in the wellbore servicing fluid. As discussed herein, the presence of the base in the wellbore servicing fluid of the present disclosure helps to minimize changes in the viscosity of the wellbore servicing fluid when a deposit, or a kick, of salt is encountered during the drilling operation. The presence of the base in the wellbore servicing fluid thereby enables improvements in its rheological properties. The present disclosure further includes a method of minimizing a change in a viscosity of a wellbore servicing fluid when a salt mixes with the wellbore servicing fluid.

As discussed herein, the viscosity of the wellbore servicing fluid can be maintained to a large extent relative to a control solution, as defined herein, when a salt is added to the wellbore servicing fluid. Salt can be added to the wellbore servicing fluid during drilling operations, when a deposit, or a kick, of salt is encountered. In this situation, the viscosity of the control solution (the diluent and the hydrophobically modified polymer, but no base) that just the moment before encountering the salt may have been sufficient is now insufficient to suspend the cuttings of the drilling operation. In contrast, the wellbore servicing fluid of the present disclosure has a diluent, a hydrophobically modified polymer, and an amount of a base, where the amount of the base adjusts a pH of the wellbore servicing fluid to greater than 10 thereby providing a viscosity that decreases no more than percent of a change of viscosity in a control solution measured at 30° C., when a predefined concentration of salt is present in each of the control solution and the wellbore servicing fluid.

As used herein, “wellbore servicing fluid” refers to an appropriate fluid to be introduced into a wellbore, whether during drilling, completion, servicing, workover or other such stage. In addition to being useful as a wellbore servicing fluid, the wellbore servicing fluid of the present disclosure can also be useful for (e.g., have a viscosity suited for), besides other things, cementitious formulations, ceramics and/or metal working fluids and/or cutting fluids.

The wellbore servicing fluid of the present disclosure includes a hydrophobically modified polymer. As used herein, the term “hydrophobically modified polymer” refers to polymers with hydrophobic groups chemically attached to a hydrophilic polymer backbone. The hydrodrophobically modified polymer can be water soluble, due at least in part to the presence of the hydrophilic polymer backbone, where the hydrophobic groups can be attached to the ends of the polymer backbone (end-capped) and/or grafted along the polymer backbone (comb-like polymers).

The hydrophobically modified polymer can be soluble in the wellbore servicing fluid at a variety of temperatures. For example, the hydrophobically modified polymer can be soluble in the wellbore servicing fluid at a temperature in a range of 0 to 65 degrees Celsius (° C.). All individual values and subranges from 0 to 65° C. are included herein and disclosed herein. For example, the hydrophobically modified polymer can be soluble in the aqueous solution at a temperature having a lower limit of 0° C., 10° C. or 20° C. to an upper limit of 43° C., 54° C. or 65° C. Examples of such ranges include, but are not limited to, 10 to 65° C.; 20 to 65° C.; 0 to 54° C.; 10 to 54° C.; 20 to 54° C.; 0 to 43° C.; 10 to 43° C.; and 20 to 43° C.

As used herein, the hydrophobically modified polymer is soluble in the wellbore servicing fluid, which means that the hydrophobically modified polymer can dissolve in a diluent and a base to form a homogeneous solution of the wellbore servicing fluid. As used herein, the term “homogeneous” as it pertains to the wellbore servicing fluid refers to a mixture of two or more substances (e.g. the diluent, the hydrophobically modified polymer, and the base) that does not visually separate into separate components. The solubility of the hydrophobically modified polymer in the diluent with base can depend on the temperature and pressure of the wellbore servicing fluid. As a result, the amount of hydrophobically modified polymer present in the wellbore servicing fluid can be dictated by the viscosity requirements of the wellbore servicing fluid in the given drilling situation.

Possible ranges for the amount of the hydrophobically modified polymer in the wellbore servicing fluid can comprise 0.01 to 5.0 weight percent (wt. %) of the wellbore servicing fluid. All individual values and subranges from 0.01 to 5.0 wt. % are included herein and disclosed herein. For example, the hydrophobically modified polymer can comprise from a lower limit of 0.01 wt. %, 0.1 wt. %, 1.0 wt. % or 2.0 wt. % to an upper limit of 0.05 wt. %, 0.2 wt. %, 0.5 wt. %, 2.0 wt. % or 5.0 wt. %. Examples of such ranges include, but are not limited to, 0.01 wt. % to 0.05 wt. %; 0.01 wt. % to 0.2 wt. %; 0.01 wt. % to 0.5 wt. %; 0.01 wt. % to 2.0 wt. %; 0.01 wt. % to 5.0 wt. %; 0.1 wt. % to 0.05 wt. %; 0.1 wt. % to 0.2 wt. %; 0.1 wt. % to 0.5 wt. %; 0.1 wt. % to 2.0 wt. %; 0.1 wt. % to 5.0 wt. %; 1.0 wt. % to 2.0 wt. %; 1.0 wt. % to 5.0 wt. %; and 2.0 wt. % to 5.0 wt. %. As appreciated, however, the amount of hydrophobically modified polymer present in the wellbore servicing fluid can be dictated by the viscosity requirements of the wellbore servicing fluid in the given drilling situation.

The hydrophobically modified polymer of the wellbore servicing fluid can have a variety of weight-average molecular weights (M_{w}). For example, the hydrophobically modified polymer of the wellbore servicing fluid can have a M_{w} of 500,000 to 4,000,000 Daltons. All individual values and subranges of the M_{w} of 500,000 to 4,000,000 Daltons are included herein and disclosed herein. For example, the M_{w} of the hydrophobically modified polymer can have a lower limit of 500,000; 1,000,000 or 1,500,000 Daltons to an upper limit of 2,500,000; 3,000,000; or 4,000,000 Daltons. Examples of such M_{w} ranges include, but are not limited to, 500,000 to 3,000,000 Daltons; 500,000 to 2,500,000 Daltons; 1,000,000 to 2,500,000 Daltons; 1,000,000 to 3,000,000 Daltons; 1,000,000 to 4,000,000 Daltons; 1,500,000 to 2,500,000 Daltons; 1,500,000 to 3,000,000 Daltons; or 1,500,000 to 4,000,000 Daltons.

In addition, the hydrophobically modified polymer can have a molecular weight distribution or polydispersity, as measured by the ratio of weight-average molecular weight versus number-average molecular weight (M_{w}/Mₙ). For example, the hydrophobically modified polymer has a M_{w}/Mₙ of 4 to 40. All individual values and subranges of the M_{w}/Mₙ of 4 to 40 are included herein and disclosed herein. For example, the M_{w}/Mₙ of the hydrophobically modified polymer can have a lower limit of 4, 8 or 14 to an upper limit of 27, 30 or 40. Examples of such M_{w}/Mₙ ranges include 4 to 27; 4 to 30; 8 to 27; 8 to 30; 8 to 40; 14 to 27; 14 to 30; and 14 to 40. The weight-average molecular weights and the molecular weight distribution of hydrophobically modified polymer present in the wellbore servicing fluid can be dictated by the viscosity requirements of the wellbore servicing fluid in the given drilling situation.

The molecular weights (number-average and weight-average) were measured via size-exclusion chromatrography (SEC) using a light-scattering detector as discussed in the Examples section below.

Examples of suitable hydrophobically modified polymers can include, but are not limited to, polysaccharides, bio-polymers and/or synthetic polymers. As used herein, the term polysaccharide can include a “hydrophobically modified polysaccharide”, which refers to a polysaccharide with hydrophobic groups chemically attached to a hydrophilic polymer backbone formed from a polymeric structure of repeating carbohydrate units joined by glycosidic bonds. Examples of the hydrophobically modified polysaccharide can include, but are not limited to, bio-polymers such as, for example, hydrophobically modified hydroxyethyl cellulose (a nonionic cellulose ether).

As used herein, the term “bio-polymer” refers to a polymeric substance, such as a protein or a polysaccharide, formed in a biological system, or a derivative of such a polymer with a substantially similar backbone. The bio-polymers can include bio-polymers that are also useful as shale stabilizer-inhibitors. The polysaccharides can further include, but are not limited to, hydrophobically modified hydroxyethyl cellulose (HMHEC). Examples of HMHEC include those sold under the trade designator EMBARK™ Rheology Modifier 160, which is commercially available from The Dow Chemical Company.

The base polymer for HMHEC is cellulose, which is a polysaccharide built up from 1,4-anhydroglucose units (AHG). The process for making HMIIEC can start with an alkalization step, which serves to swell the cellulose making the cellulose chains available for the chemical reaction. The alkalization step acts to catalyze the modification reactions with ethylene oxide. Each AHG has three hydroxyl groups available for reaction. The reaction of one ethylene oxide molecule to one of the hydroxyl groups on an AHG results in a new hydroxyl group that is also reactive. The newly formed hydroxyl group has a reactivity comparable to that of the hydroxyl groups on the AHG which means that besides the reaction of the hydroxyl groups on the AHG there is also a chain growth reaction occurring. The outcome is that short oligo (ethylene oxide) chains are formed. Ethylene oxide molar substitution (EO MS) is the average total number of ethylene oxide groups per AHG.

The HMHEC of the present disclosure includes hydroxyethyl groups, as discussed herein, and can be further substituted with one or more hydrophobic substituents. The EO MS of the polymers prepared from hydroxyethyl cellulose can be determined either by simple mass gain or using the Morgan modification of the Zeisel method: P. W. Morgan, Ind. Eng. Chem., Anal. Ed., 18, 500-504 (1946). The procedure is also described in ASTM method D-2364 (2007). In one or more embodiments, HMHEC has an EO MS from 0.5 to 3.5. All individual values and subranges from 0.5 to 3.5 of the EO MS value are included herein and disclosed herein. For example, the EO MS value for the HMHEC can have a lower limit of 0.5, 1.0 or 1.5 to an upper limit of 2.5, 3.0 or 3.5. Examples of such ranges include, but are not limited to, 0.5 to 2.5, 0.5 to 3.0, 1.0 to 2.5, 1.0 to 3.0, 1.0 to 3.5, 1.5 to 2.5, 1.5 to 3.0, and 1.5 to 3.5.

The HMHEC's of the present disclosure can also be substituted with one or more hydrophobic substituents. Examples of such substituents include, but are not limited to, acyclic and/or cyclic, saturated and/or unsaturated, branched and/or linear hydrocarbon groups and combinations thereof. Examples of such hydrocarbon groups include, but are not limited to, alkyl, alkylaryl and/or arylalkyl groups having at least 8 carbon atoms, generally from 8 to 32 carbon atoms, preferably from 10 to 30 carbon atoms, more preferably from 12 to 24 carbon atoms, and most preferably from 12 to 18 carbon atoms. As used herein the terms “arylalkyl group” and “alkylaryl group” refer to groups containing both aromatic and aliphatic structures.

The average number of moles of the hydrophobic substituent(s) per mole of anhydroglucose unit is designated as hydrophobe degree of substitution (hydrophobe DS). The DS is measured using the Morgan modification of the Zeisel method as provided herein, but using a gas chromatograph to measure the concentration of cleaved alkyl groups. An example of a gas chromatographic method that can be used for this purpose is described in ASTM method D-4794 (2009). In the case of alkylaryl hydrophobes such as dodecylphenyl glycidyl ether, the spectrophotometric method described in U.S. Pat. No. 6,372,901 issued Apr. 16, 2002, incorporated herein by reference in its entirety, can be used to determine the hydrophobe DS.

The hydrophobe DS for the HMHEC is from 0.001 to 0.025 moles of the hydrophobic substituent(s) per mole of anhydroglucose unit. All individual values and subranges from 0.001 to 0.025 moles of the hydrophobic substituent(s) per mole of anhydroglucose unit are included herein and disclosed herein. For example, the hydrophobe DS for the HMHEC can have a lower limit of 0.001, 0.0059, 0.007, or 0.01 to an upper limit of 0.012, 0.015, 0.018 or 0.025. Examples of such ranges include, but are not limited to, 0.001 to 0.012; 0.001 to 0.015; 0.001 to 0.018; 0.001 to 0.025; 0.0059 to 0.012; 0.0059 to 0.015; 0.0059 to 0.018; 0.0059 to 0.025; 0.007 to 0.012; 0.007 to 0.015; 0.007 to 0.018; 0.007 to 0.025; 0.01 to 0.012; 0.01 to 0.015; 0.01 to 0.018; and 0.01 to 0.025. The hydrophobe DS is preferably at least 0.007, more preferably at least 0.010, most preferably at least 0.012, and in particular at least 0.015 moles of the hydrophobic substitucnt(s), per mole of anhydroglucose unit. The average substitution level of the hydrophobic substituent(s) is generally up to 0.025, typically up to 0.018.

The upper limit of hydrophobe substitution is determined by the water solubility of the resulting nonionic cellulose ether. With increasing hydrophobe substitution, a point is reached at which the resulting polymer is water-insoluble. This upper limit varies somewhat depending on the specific hydrophobe used and the method in which it is added. More than one type of hydrophobic substituent can be substituted onto the cellulose ether, but the total substitution level is preferably within the ranges set forth herein.

The amount of diluent used in the wellbore servicing fluid can be highly dependent on the amount of salt, if any, that may be present in the diluent (e.g., in the case of a brine being used as the diluent). As a general guide, the diluent can comprise 30 to 99.9 weight percent (wt. %) of the wellbore servicing fluid. All individual values and subranges from 30 to 99.9 wt. % are included herein and disclosed herein. For example, the diluent can comprise from a lower limit of 30 wt. %, 40 wt. % or 50 wt. % to an upper limit of 99.9 wt. %, 99.8 wt. % or 99.5 wt. %. Examples of such ranges include, but are not limited to, 40 wt. % to 99.9 wt. %; 50 wt. % to 99.9 wt. %; 30 wt. % to 99.8 wt. %; 40 wt. % to 99.8 wt. %; 50 wt. % to 99.8 wt. %; 30 wt. % to 99.5 vd.%; 40 wt. % to 99.5 wt. %; and 50 wt. % to 99.5 wt. %.

Surprisingly, the present disclosure has found that the addition of an amount of a base to the wellbore servicing fluid sufficient to adjust a pH of the wellbore servicing fluid to greater than 10 helps to minimize changes in the viscosity of the wellbore servicing fluid that would otherwise take place in the absence of the base (and the pH of greater than 10). As discussed herein, during the drilling process the wellbore servicing fluid is used to help remove the cuttings. To remove the cuttings, the wellbore servicing fluid is pumped under pressure down the center of a string of drilling pipes and through the drill bit at the bottom of the wellbore as it is being created. If a deposit of salt and/or brine is encountered during the drilling (also known as a salt kick or salt water kick) the viscosity of the wellbore servicing fluid might be negatively impacted. Specifically, the viscosity of the wellbore servicing fluid can be quickly reduced to a value that is insufficient to suspend and remove the cuttings.

As discussed herein, the amount of the base added to the wellbore servicing fluid adjusts the pH of the wellbore servicing fluid to more than 10. Values for pH that are greater than 10 are also possible. For example, the amount of the base added to the wellbore servicing fluid adjusts the pH of the wellbore servicing fluid to at least 11. The amount of the base added to the wellbore servicing fluid can also adjust the pH of the wellbore servicing fluid to at least 12. In addition, the amount of the base added to the wellbore servicing fluid can adjust the pH of the wellbore servicing fluid to at least 13. Specific examples of pH values achieved by adding the amount of the base to the wellbore servicing fluid include, but are not limited to, 10.5, 11.0, 12.0, 12.5, 13.0, 13.3 13.5 and 13.7.

Examples of the base for the wellbore servicing fluid include, but are not limited to, an inorganic base selected from the group consisting of sodium hydroxide, potassium hydroxide, ammonium hydroxide, calcium hydroxide and combinations thereof. Other bases include, but are not limited to, organic bases such as morpholine, 4-ethylmorpholine, monoethanolamine, diethanolamine, triethanolamine, aminoethylethanolamine, propylamine, isopropylamine, butylamine, sec-butylamine, tert-butylamine, isobutylamine, furfurylamine, cyclohexylamine, 3-amino-1-propanol, ethylenediamine, and combinations thereof. Other suitable organic bases can be found in “Mutual Solubility of Water and Aliphatic Amines” by Richard M. Stephenson, J. Chem. Eng. Data 1993, 38, 625-629 and “Mutual Solubilities: Water+Cyclic Amines, Water+Alkanolamines, and Water+Polyamines” by Richard M. Stephenson, J. Chem. Eng. Data 1993, 38, 634-637, both of which are incorporated herein by reference in their entirety.

Furthermore, the base of the wellbore servicing fluid can share the same cation as the salt that may be introduced into or present in the wellbore servicing fluid. A non-limiting example is when sodium chloride (NaCl) might be possibly encountered during the drilling process, in such a case sodium hydroxide (NaOH) is used as the base (the salt, NaCl, and the base, NaOH, would share the same cation Na⁺). The base and salt can also have different cations. A non-limiting example is when potassium chloride (KCl) might be possibly encountered during the drilling process, calcium hydroxide (Ca(OH)₂) can be used as the base (the salt, KCl, and the base, Ca(OH)₂, would have different cations K⁺ and Ca²⁺).

An example of a salt that might be encountered during the drilling process includes, but is not limited to, a halide. As used herein, the term “halide” refers to a chemical compound, more particularly a salt, which comprises a halogen. The halogen can include a group 17 element (i.e., fluorine, chlorine, bromine, iodine, and/or astatine as defined in the International Union of Pure and Applied Chemistry (IUPAC) Periodic Table of the Elements dated Jun. 22, 2007). Examples of the salt can also include a monovalent salt. Preferably, the salt is a monovalent salt.

Specific examples of the halide salt include, but are not limited to sodium chloride, potassium chloride, calcium chloride, zinc chloride, sodium bromide, potassium bromide, calcium bromide, zinc bromide and combinations thereof. In one embodiment, the halide salt is sodium chloride. Further examples of the salt include formates. As used herein, the term “formate” refers to a chemical compound that comprises the formate (HCO₂⁻) anion. Specific examples of formates include sodium formate, potassium formate, cesium formate, and combinations thereof.

As appreciated by one skilled in the art, in the field the amount of salt possibly encountered during a drilling operation can vary from no salt (e.g., a concentration of zero (0)) up to a saturation concentration for the given temperature of the wellbore servicing fluid. For example, salt encountered during the drilling process can mix with the wellbore servicing fluid at a variety of different concentration values. For example, the salt can mix with the wellbore servicing fluid up to a concentration of at least ninety (90) percent saturation, at least seventy five (75) percent saturation or at least fifty (50) percent saturation at the temperatures discussed herein with respect to the solubility of the hydrophobically modified polymer in the wellbore servicing fluid discussed above.

As provided herein, a bench top approach is used to demonstrate the ability of the wellbore servicing fluid to minimize changes in the viscosity relative to a control solution. For these bench top experiments, the control solution is defined as the diluent and the hydrophobically modified polymer, without a base. The wellbore servicing fluid includes the diluent, the hydrophobically modified polymer, and the base to adjust the pH of the wellbore servicing to greater than 10. To each of the control solution and the wellbore servicing fluid, a predefined concentration of salt is added. This predefined concentration of salt is intended to mimic a salt kick encountered during a drilling operation. This bench top approach helps to demonstrate the ability of the wellbore servicing fluid to minimize changes in the viscosity of the wellbore servicing fluid.

As with the situation discussed above for salt encountered during the drilling operation, the predefined concentration of salt used in this bench top approach can vary from a concentration of zero (0) up to a saturation concentration for the given temperature of the wellbore servicing fluid. For example, the predefined concentration of salt used with the wellbore servicing fluid can be more than fifty (50) percent of the saturation concentration of the salt. The predefined concentration of salt used with the wellbore servicing fluid can be more than seventy five (75) percent of the saturation concentration of the salt. The predefined concentration of salt used with the wellbore servicing fluid can be more than ninety (90) percent of the saturation concentration of the salt.

Data from the bench top approach is used to provide a ratio of the relative change in viscosity for each of the wellbore servicing fluid and the control solution for a given predefined concentration of salt added. This relative change in viscosity is used to demonstrate the ability of the wellbore servicing fluid of the present disclosure to minimize changes in viscosity, relative to the control solution, when the predefined concentration of salt is added. Specifically, the relative change in viscosity is calculated as the difference in viscosity of the wellbore servicing fluid (WSF) without the predefined concentration of salt (WSF without salt) and with the predefined concentration of salt (WSF with salt) divided by the difference in viscosity of the control solution (CS) without the predefined concentration of salt (CS without salt) and with the predefined concentration of salt (CS with salt). In equation form, the relative change in viscosity is as follows:

$$Relative change in viscosity = \frac{( WSF without salt ) - ( WSF with salt )}{( CS without salt ) - ( CS with salt )}$$

The relative change in viscosity is determined at a predetermined temperature. For example, the predetermined temperature used in determining the relative change in viscosity can be 30° C. As discussed more fully in the Examples section below, the relative change in viscosity for the wellbore servicing fluid of the present disclosure can have a value of less than 0.33; a value of less than 0.74; a value of less than 0.86 or a value of less than 0.91. As appreciated, these values reflect the relative change (e.g., drop) in viscosity of the wellbore servicing fluid and the control solution upon adding the predefined concentration of salt.

So, the amount of the base adjusts the pH of the wellbore servicing fluid to greater than 10 thereby providing a viscosity that decreases no more than 33 percent of a change of viscosity in a control solution, each viscosity measured at 30° C. according to the present disclosure, when the predefined concentration of salt is present in each of the control solution and the wellbore servicing fluid. In an additional embodiment, the amount of the base adjusts the pH of the wellbore servicing fluid to greater than 10 thereby providing a viscosity that decreases no more than 74 percent of a change of viscosity in a control solution, each viscosity measured at 30° C. according to the present disclosure, when the predefined concentration of salt is present in each of the control solution and the wellbore servicing fluid. In another embodiment, the amount of the base adjusts the pH of the wellbore servicing fluid to greater than 10 thereby providing a viscosity that decreases no more than 86 percent of a change of viscosity in a control solution, each viscosity measured at 30° C. according to the present disclosure, when the predefined concentration of salt is present in each of the control solution and the wellbore servicing fluid. In yet another embodiment, the amount of the base adjusts the pH of the wellbore servicing fluid to greater than 10 thereby providing a viscosity that decreases no more than 91 percent of a change of viscosity in a control solution, each viscosity measured at 30° C. according to the present disclosure, when the predefined concentration of salt is present in each of the control solution and the wellbore servicing fluid.

The wellbore servicing fluid of the present disclosure can either be used in isolation (e.g., “neat”) or can be combined with other additives. For example, the wellbore servicing fluid of the present disclosure can also be combined with conventional drilling muds. Dry components used in forming the wellbore servicing fluid (e.g., the base and the hydrophobically modified polymer) of the present disclosure can be “dry blended” together for subsequent blending with a diluent. Once blended, the wellbore servicing fluid can be used for one or more of a wellbore servicing fluid, a cementitious formulation, a ceramic and/or metal working fluid and/or a cutting fluid.

The wellbore servicing fluid of the present disclosure can be prepared (on or off site where it will be used) and stored in a tank or storage basin. The wellbore servicing fluid so prepared can then, for example, be fed into a wellbore for use as the well bore servicing fluid. Alternatively, the wellbore servicing fluid can be fed directly into the wellbore as individual components, or combinations of individual components (e.g., is mixed while being fed or injected into the wellbore). Preparing the wellbore servicing fluid of the present disclosure can be accompl shed through the use of rotational, pneumatic, hydraulic and/or static mixers. When the wellbore servicing fluid is fed into the wellbore, mixing can occur through static mixing as the wellbore servicing fluid is fed toward the drill bit.

The present disclosure further provides a method of maintaining a viscosity of the wellbore servicing fluid when a salt mixes with the wellbore servicing fluid, where the method includes providing an admixture of the diluent and the hydrophobically modified polymer. A base is added to the admixture to provide the wellbore servicing fluid with a pH of greater than 10 that maintains the viscosity of the wellbore servicing fluid sufficient to maintain drilling operations when the salt is present in the wellbore servicing fluid. As used herein, the phrase sufficient to maintain drilling operations includes the ability of the wellbore servicing fluid to suspend the cuttings in the wellbore servicing fluid when a flow of the wellbore servicing fluid has come to a stop, such that operations can be re-started without incident following the dormant period (typically several hours to several days in duration).

The method can include adding the base to provide the wellbore servicing fluid with a viscosity, measured at 30° C. according to the present disclosure, which decreases no more than 33 percent of a change of viscosity in the control solution, measured at 30° C. according to the present disclosure, when the predefined concentration of the salt is present in (e.g., is added according to the bench top approach discussed above) in each of the control solution and the wellbore servicing fluid. Other values for this relative decrease, besides 33 percent, can include a decrease of no more than 74 percent, a decrease of no more than 86 percent or a decrease of no more than 91 percent, as was discussed above.

The method can include using the wellbore servicing fluid, as described herein, as at least one of a wellbore servicing fluid, a cementitious formulation, a ceramics and/or metal working fluid and/or a cutting fluid. The salt concentration of the wellbore servicing fluid can be present in the wellbore servicing fluid at a concentration of more than fifty percent of the saturation concentration. The presence of salt in the wellbore servicing fluid can also act to adjust the density of the wellbore servicing fluid and/or acting as an inhibitor, preventing or retarding the wellbore servicing fluid from hydrating formation clays or salt formations that are being drilled through.

The pH of the wellbore servicing fluid can also be adjusted to values greater than 10 to minimize changes in the viscosity of the wellbore servicing fluid. For example, adding the base can include adjusting the pH of the wellbore servicing fluid containing the salt to a value of greater than 10 to increase the viscosity of the wellbore servicing fluid to a value greater than the viscosity at the pH of 10. The pH value of the wellbore servicing fluid can be adjusted to the values discussed herein. Such examples include, but are not limited to, where the pH is at least 11.0, where the pH is at least 12.0, where the pH is at least 12.5, where the pH is at least 13.0, where the pH is at least 13.3, where the pH is at least 13.5 and where the pH is at least 13.7. These pH values help to increase the viscosity of the wellbore servicing fluid and help to minimize changes in the viscosity due to the introduction of a salt into the wellbore servicing fluid.

For the various embodiments, the viscosity can be measured several ways. For example, rheological properties can be measured using a Fann Series 35 viscometer. Other rheometers can also be used to measure rheological properties. Examples of such rheometers include a Chandler Engineering AMETEK® Model 5550 HPHT Pressurized Viscometer (Chandler Engineering, Broken Arrow OK) and a Grace Instrument M5600 HPHT Rheometer (Grace Instrument, Houston Tex.).

The pH value of the wellbore servicing fluid can also be varied to adjust the fluid loss properties of the wellbore servicing fluid. Fluid loss properties can be expressed in terms of a filtration rate and can be determined by measuring the amount of liquid forced from the wellbore servicing fluid, through a filter paper at a set pressure and time (normally 100 pounds per square inch at 30 minutes). Fluid loss properties can also be determined by analyzing the filter cake that has deposited on the filter paper (e.g. measuring thickness and/or density of the filter cake).

In addition to being used as a wellbore servicing fluid, the wellbore servicing fluid of the present disclosure may also be used in applications which a high suspending capability is a performance attribute and higher viscosities at lower polymer loadings are desired. Examples of such applications include water, petroleum and natural gas recovery operations, as discussed herein (e.g., drilling fluids, workover fluids, or completion fluids; cementing wells, and hydraulic fracturing), construction operations (e.g., concrete pumping and casting, self-leveling cement, cementing geothermal wells, extruded concrete panels), full-depth road reclamation, ceramics (e.g., as green strength additive), metal working and cutting fluids, among others.

In some embodiments, the wellbore servicing fluid of the present disclosure can also include other additives. For example, the wellbore servicing fluid can include additives such as corrosion inhibitors, weighting agents, surfactants, co-surfactants, scale inhibitors, shale inhibitors, lubricants, antioxidants and mixtures thereof, as well as other additives.

### EXAMPLES

The following examples are given to illustrate, but not limit, the scope of this disclosure. Unless otherwise indicated, percentages are by weight. Weight percent is the percentage of one compound included in a total mixture, based on weight. The weight percent can be determined by dividing the weight of one component by the total weight of the mixture and then multiplying by 100. Unless otherwise specified, all instruments and chemicals used are commercially available.

The following procedure exemplifies a standard procedure for making the wellbore servicing fluid and measuring the viscosity of the resulting wellbore servicing fluid. In addition, one skilled in the art will appreciate that this is an exemplary procedure and that other components can be substituted or removed in the procedure to make a similar wellbore servicing fluid.

### Materials

Sodium chloride (reagent grade, VWR); Potassium chloride (reagent grade, VWR); Deionized water; Sodium hydroxide (Pellets/Certified ACS, Fisher Scientific); Potassium hydroxide (Pellets/Certified ACS, Fisher Scientific); CELLOSIZE® HEC QP-52,000H hydroxyethyl cellulose (The Dow Chemical Company); CELLOSIZE® HEC QP-100MH hydroxyethyl cellulose (The Dow Chemical Company); Isopropyl alcohol (reagent grade, VWR); Nitrogen (Ultra High Purity Grade, Airgas); 1-Bromohexadecane (n-C₁₆H₃₃Br, Sigma-Aldrich); Glacial acetic acid (99.99%, Sigma-Aldrich); Acetone (Certified ACS, Fisher Scientific); Aqueous glyoxal (40% wt % in H₂O, Sigma-Aldrich); Sodium azide (NaN₃, Sigma-Aldrich); and β-cyclodextrin (β-CD, Sigma-Aldrich).

### Preparation of Hydrophobically Modified Hydroxyethyl Cellulose (Polymer 1)

Fit a 3000 mL three-necked round bottomed flask with a mechanical stirring paddle, a nitrogen inlet, a rubber serum cap, and a reflux condenser connected to a mineral oil bubbler. Charge the resin kettle with 199.94 g (184.46 g contained) of CELLOSIZE® HEC QP-52,000H hydroxyethyl cellulose, 1056 g of isopropyl alcohol, and 144 g of deionized water. While stirring the mixture, purge the resin kettle with nitrogen for one hour to remove any entrained oxygen in the system. While stirring under nitrogen, add 24.79 g of 50 wt. % aqueous sodium hydroxide solution drop-wise over five minutes using a syringe. Allow the mixture to stir for 30 minutes under nitrogen.

Heat the mixture to reflux with stirring under nitrogen. At reflux, add 22.53 g of 1-bromohexadecane slowly over 5 minutes. Hold the mixture at reflux for 4.5 hours with stirring under nitrogen. Cool the mixture to room temperature and neutralize by adding 31.0 g of glacial acetic acid and stir for 10 minutes. Recover the polymer by vacuum filtration and wash in a Waring blender: four times with 1500 mL of 4:1 (by volume) of acetone/water and twice with 1500 mL of pure acetone. Treat the polymer by adding 2.5 g of 40% aqueous glyoxal and 1.5 g of glacial acetic acid to the last acetone desiccation. Dry the polymer in vacuo at 50° C. overnight, yielding 192.81 g of an off-white powder with a volatiles content of 6.00 wt. % and an ash content (as sodium acetate) of 2.58 wt. %. The hydrophobe DS (by Zeisel analysis) was found to be 0.0058.

### Preparation of Hydrophobically Modified Hydroxyethyl Cellulose (POLYMER 2)

Fit a 500 mL three-necked round bottomed flask with a mechanical stirring paddle, a nitrogen inlet, a rubber serum cap, and a reflux condenser connected to a mineral oil bubbler. Charge the resin kettle with 22.3 g (20.0 g contained) of CELLOSIZE® HEC QP-100MH hydroxyethyl cellulose, 118 g of isopropyl alcohol, and 16 g of deionized water. While stirring the mixture, purge the resin kettle with nitrogen for one hour to remove any entrained oxygen in the system. While stirring under nitrogen, add 2.69 g of 50 wt. % aqueous sodium hydroxide solution drop-wise over five minutes using a syringe. Allow the mixture to stir for 30 minutes under nitrogen.

Heat the mixture to reflux with stirring under nitrogen. At reflux, add 2.44 g of 1-bromohexadecane slowly over 5 minutes. Hold the mixture at reflux for 4.5 hours with stirring under nitrogen. Cool the mixture to room temperature and neutralize by adding 5 g of glacial acetic acid and stir for 10 minutes. Recover the polymer by vacuum filtration and wash in a Waring blender: four times with 250 mL of 4:1 (by volume) of acetone/water and twice with 250 mL of pure acetone. Treat the polymer by adding 0.4 g of 40% aqueous glyoxal and 0.25 g of glacial acetic acid to the last acetone desiccation. Dry the polymer in vacuo at 50° C. overnight, yielding 16.47 g of an off-white powder with a volatiles content of 1.63 wt % and an ash content (as sodium acetate) of 1.26 wt. %. The hydrophobe DS (by Zeisel analysis) was found to be 0.0050.

### Equipment

A Fann Series 35 viscometer with a temperature-controlled solution and six shear rate speed (i.e., 3, 6, 100, 200, 300, and 600 revolutions per minute (rpm)) control was used to measure changes in viscosity. The viscometer was calibrated using the fluid calibration check instrument calibration procedure detailed in the Model 35 Viscometer Instruction Manual (Part No. 354960001 EA). The calibration fluid was a Cannon certified viscosity reference mineral oil having a kinematic viscosity of 33.85 cps at 25.00° C.

In obtaining data from the viscometer, the R1 closed-end stainless steel rotor, B1 stainless steel hollow bob, F1 torsion spring, and 115 volt (2 amp) Thermocup sample cup were used. The temperature of the solution was measured using a thermocouple inserted in the test solution.

In addition to the Farm Series 35 viscometer, a Chandler Engineering AMETEK® Model 5550 HPHT pressurized viscometer (Chandler Engineering, Broken Arrow, Okla.) and a Grace Instrument M5600 HPHT rheometer (Grace Instrument, Houston, Tex.) were also used to measure viscosities of the Examples provided herein.

Measurement of Molecular Weight was Made by Size-Exclusion Chromatography (SEC):

Mobile Phase—

The eluent consists of 0.05 weight percent (wt %) sodium azide (NaN₃) and 0.75 wt % β-cyclodextrin (β-CD) dissolved in deionized (DI) water. All eluent compositions were prepared by dissolving NaN₃ and β-CD in DI water that had been filtered through a 0.2 μm nylon cartridge. The mobile phase was filtered through a 0.2 μm nylon membrane prior to use.

Sample Preparation—

Sample solutions were prepared in the mobile phase to minimize interference from any salt peak. The target sample concentration was 0.3 mg/mL in order to be sufficiently below C*, the intermolecular polymer chain overlap concentration. Solutions were slowly shaken on a flat bed shaker for 2-3 hours to dissolve the samples, and then were stored overnight in a refrigerator set at 4° C. for complete hydration and dissolution. On the second day, solutions were shaken again for 1-2 hours. All solutions were filtered through a 0.45 μm nylon syringe filter prior to injection.

SEC Equipment—

Pump: Waters 2690 set at 0.5 mL/min flow rate and equipped with a filter that consists of two layers of 0.2 μm nylon membrane installed upstream of the injection valve. Injection: Waters 2690 programmed to inject 100 microliters of solution. Columns: Two TSK-GEL GMPW columns (7.5 mm ID×30 cm, 17 μm particles, 100 Å to 1000 Å pores nominal) were operated at 30° C. Detector: A Waters DRI detector 2410 was operated at 30° C.

Calibration—

The conventional SEC calibration was determined using 11 narrow PEO (polyethylene oxide) standards (linear, narrow molecular weight PEO standards were purchased from TOSOH, Montgomeryville, Pa.). The calibration curve was fit to a first order polynomial over the range of 879 kg/mol to 1.47 kg/mol.

### Software—

Data were acquired and reduced using Cirrus SEC software version 2.0.

### Comparative Examples A to F

Comparative Example A to F are blank samples, i.e., do not contain sodium hydroxide or sodium chloride. Comparative examples A to F use POLYMER 1.

### Comparative Example A

Add POLYMER 1 to deionized water in an amount so as to provide a 1 weight percent (wt. 20%) concentration of POLYMER 1. Stir the mixture to form a homogenous solution, and place in a Farm Series 35 viscometer and heat to a temperature of 27° C. Adjust the speed of the viscometer to rpm, 300 rpm, 200 rpm, 100 rpm, 6 rpm, and then to 3 rpm and take readings from the Fann dial at each interval rpm. The pH of comparative Example A is about 7.

### Comparative Example B

Perform Comparative Example B using the same method as Comparative Example A except heat the solution to 41° C. The pH of comparative Example B is about 7.

### Comparative Example C

Perform Comparative Example C using the same method as Comparative Example A except heat the solution to 48° C. The pH of comparative Example C is about 7.

### Comparative Example D

Perform Comparative Example D using the same method as Comparative Example A except heat the solution to 62° C. The pH of comparative Example D is about 7.

### Comparative Example E

Perform Comparative Example E using the same method as Comparative Example A except heat the solution to 70° C. The pH of comparative Example E is about 7.

### Comparative Example F

Perform Comparative Example F using the same method as Comparative Example A except heat the solution to 50° C. The pH of comparative Example F is about 7.

The results for Comparative Examples (Corn. Ex.) A to F are provided in Table I.

TABLE I

| | | | | | | Speed Setting (rpm) | | | | | |
|---|---|---|---|---|---|---|---|---|---|---|---|
| | | Conc | | | | 600 | 300 | 200 | 100 | 6 | 3 |
| Product | Polymer | (wt. %) | Base/Salt | pH | Temp (° C.) | Fann Dial Reading* | | | | | |
| Com. | POLYMER 1 | 1 | None | 7 | 27 | 228 | 184 | 164 | 135 | 74 | 64 |
| Ex. A | | | | | | | | | | | |
| Com. | POLYMER 1 | 1 | None | 7 | 41 | 197.5 | 158 | 139 | 115 | 68 | 59.5 |
| Ex. B | | | | | | | | | | | |
| Com. | POLYMER 1 | 1 | None | 7 | 48 | 169.5 | 137 | 122 | 101 | 55 | 47 |
| Ex. C | | | | | | | | | | | |
| Com. | POLYMER 1 | 1 | None | 7 | 62 | 140 | 114 | 101.5 | 86.5 | 45 | 37.5 |
| Ex. D | | | | | | | | | | | |
| Com. | POLYMER 1 | 1 | None | 7 | 70 | 128.5 | 104 | 94 | 78.5 | 37 | 29.5 |
| Ex. E | | | | | | | | | | | |
| Com. | POLYMER 1 | 1 | None | 7 | 50 | 168 | 136.5 | 121.5 | 101.5 | 57.5 | 49.5 |
| Ex. F | | | | | | | | | | | |

*Readings taken from the Fann Dial are left unitless due to the direct correlation between the dial reading and the viscosity as discussed in the Calculations section below.

### Examples 1 to 5

Examples 1 to 5 contain a concentration of POLYMER 1, sodium hydroxide, sodium chloride and deionized water, as follows.

### Example 1

Combine and stir deionized water, sodium chloride and sodium hydroxide to form a clear solution in a few minutes, and then add POLYMER 1 so as to provide a solution consisting of 23.8 weight percent sodium chloride, 0.19 weight percent sodium hydroxide, and 0.75 weight percent POLYMER 1, with the balance being deionized water. Stir the mixture to form a homogenous solution. Place a portion of the solution in a Fann Series 35 viscometer and heated to a temperature of 48° C. Adjust the speed of the viscometer to 600 rpm, 300 rpm, 200 rpm, 100 rpm, rpm, and then to 3 rpm and take readings from the Fann dial at each interval rpm. The pH of Example 1 is about 12.7.

### Example 2

Combine and stir deionized water, sodium chloride and sodium hydroxide to form a clear solution in a few minutes, and then add POLYMER 1 so as to provide a solution consisting of 22.6 weight percent sodium chloride, 1.5 weight percent sodium hydroxide, and 1.0 weight percent POLYMER 1, with the balance being deionized water. After stirring for several hours using a Teflon-coated stir bar and a magnetic stirring motor, a clear colorless solution is obtained. Place a portion of the solution in a Farm Series 35 viscometer and heated to a temperature of 32° C. Adjust the speed of the viscometer to 600 rpm, 300 rpm, 200 rpm, 100 rpm, 6 rpm, and then to 3 rpm and take readings from the Farm dial at each interval rpm. The pH of Example 2 is about 13.6.

### Example 3

Perform Example 3 using the same method as Example 2 except heat the solution to 49° C. The pH of Example 3 is about 13.6.

### Example 4

Perform Example 4 using the same method as Example 2 except heat the solution to 71° C. The pH of Example 4 is about 13.6.

### Example 5

Perform Example 5 using the same method as Example 2 except heat the solution to 50° C. The pH of Example 5 is about 13.6.

The results for Examples 1 to 5 are provided in Table II.

TABLE II

| | | | | | | Speed Setting (rpm) | | | | | |
|---|---|---|---|---|---|---|---|---|---|---|---|
| | | Conc | | | Temp | 600 | 300 | 200 | 100 | 6 | 3 |
| Product | Polymer | (wt. %) | Base/Salt | pH | (° C.) | Fann Dial Reading* | | | | | |
| Ex. 1 | POLYMER 1 | 0.75 | NaOH/NaCl | 12.7 | 48 | 20.5 | 11.5 | 8.5 | 5 | 1 | 1 |
| Ex. 2 | POLYMER 1 | 1 | NaOH/NaCl | 13.6 | 32 | >300 | 267.5 | 221.5 | 165.5 | 49 | 35 |
| Ex. 3 | POLYMER 1 | 1 | NaOH/NaCl | 13.6 | 49 | 141 | 98 | 85.5 | 66 | 27 | 21.5 |
| Ex. 4 | POLYMER 1 | 1 | NaOH/NaCl | 13.6 | 71 | 14 | 8 | 5 | 3 | 1 | 1 |
| Ex. 5 | POLYMER 1 | 1 | NaOH/NaCL | 13.6 | 50 | 103.5 | 83 | 75 | 65 | 22 | 15.5 |

*Readings taken from the Fann Dial were left unitless due to the direct correlation between the dial reading and the viscosity as discussed in the Calculations section below.

### Calculations

Calculate viscosity values from the Farm viscosity reading using an assumption of Newtonian fluid dynamics. To determine Newtonian viscosities in units of centipoise (cP) with the Fann viscometer, use the following formula (eqn. 1) (referenced in the Model 35 Instruction Manual Part No. 354960001EA). η=(S)(?)(f)(C) (eqn. 1) Where, S=Speed factor; ?=Dial reading; f=Spring factor; C=Rotor-bob factor; and η=Newtonian viscosity (cP).

In reference to the examples herein, the speed factor, spring factor, and rotor-bob factor are held constant between Comparative Examples A to F and Examples 1 to 5. A change in dial reading (?) is then proportional to a change in the Newtonian viscosity (η). Therefore, although Farm dial readings were left unitless in Table I and Table II, a direct comparison of the Fann dial readings in Table I with the Fann dial readings of Table II can be made for making a determination of the effect of the addition of a base and a salt.

The data in Table I and Table II illustrate that the addition of a hydrophobically modified polymer, in this case POLYMER 1, to a wellbore servicing fluid of sodium chloride with an amount of sodium hydroxide present in a sufficient amount to dissolve the hydrophobically modified polymer gives advantaged rheological performance (i.e., higher viscosity) relative to the same hydrophobically modified polymer in deionized water at low temperatures. It can further be seen by comparing Ex 1 to Ex 3 that addition of sufficient base appears to help in attaining the advantaged rheological properties. Without wishing to be bound by theory, addition of base is anticipated to increase the level of deprotonation along the polymer backbone rendering the polymer more water soluble due to favorable interactions of anionically charged substituents with water molecules. In addition, the electrostatic repulsions along the polymer backbone that are generated by reaction of the polymer with a strong base may help to prevent the polymer from coiling, keeping the polymer chains more fully extended.

Further, surprisingly it has been found that the formulation of Examples 1 to 5 have high gel strength demonstrated by the fact that the dial deflection of the Fann Series 35 Viscometer did not return to zero after agitation, even after sitting static for five minutes.

### Examples 6 to 17

Examples 6 to 13 contain a concentration of either POLYMER 1 or POLYMER 2 in water and either a combination of sodium hydroxide and sodium chloride or potassium hydroxide and potassium chloride, as provided herein, while Examples 14 to 17 contain a concentration of either POLYMER 1 or POLYMER 2 in water and either sodium hydroxide or potassium hydroxide. Viscosity measurements are taken on Examples 6 to 17, as discussed herein, using a Chandler Engineering AMETEK® Model 5550 HPHT pressurized viscometer (Chandler Engineering, Broken Arrow, Okla.) or a Grace Instrument M5600 HPHT rheometer (Grace Instrument, Houston, Tex.). Both of these instruments allow for a direct measurement of the viscosity of a given sample without the need to assume Newtonian fluid dynamics. This data, in addition to the data provided by the Fann Series 35 viscometer, illustrate similar trends and phenomenon of the wellbore servicing fluid of the present disclosure.

### Example 6

Combine and stir enough sodium chloride and sodium hydroxide with deionized water to form a solution having 4 molality sodium chloride (i.e., 4 moles of sodium chloride per kg of deionized water, which is 65% saturation at 20° C.) and 1 mole percent (mol. %) sodium hydroxide based on moles of water present. A clear solution forms after 5-10 minutes. Add POLYMER 1 to the solution so as to provide a wellbore servicing fluid having 1 weight percent POLYMER 1 (based on the amount water). The wellbore servicing fluid is stirred for approximately 15 hours. Place 52 milliliters (mL) of the wellbore servicing fluid in the Chandler EngineeringlAmtek Model 5550 HTHP pressurized viscometer. Pressurize the viscometer to 500 pounds per square inch (psi) and a temperature program is run as follows: Data collected every 60 seconds, shear rate=20 sec⁻¹, initial temperature=80° F. (27° C.) (hold 20 minutes), temperature ramp rate equals 1.3 degree ° F./minute, final temperature 3201 (160° C.) (hold 3 minutes). The pH of Example 6 was 13.0.

### Example 7

Perform Example 7 using the same method as Example 6 except instead of adding POLYMER 1, add POLYMER 2 to the solution so as to provide a wellbore servicing fluid having weight percent POLYMER 2 (based on the amount of water). The pH of Example 7 was 13.0.

### Example 8

Perform Example 8 using the same method as Example 6 except combine and stir enough sodium hydroxide with water and the sodium chloride to form a solution having 4 molality sodium chloride (i.e., 4 moles of sodium chloride per kg of water, which is 65% saturation at 20° C.) and 0.2 mole percent (mol. %) sodium hydroxide based on moles of water present. The pH of Example 8 was 12.5.

### Example 9

Perform Example 9 using the same method as Example 6 except instead of adding POLYMER 1, add POLYMER 2 to the solution so as to provide a wellbore servicing fluid having 1 weight percent POLYMER 2 (based on the amount of water) and combine and stir enough sodium hydroxide with water and the sodium chloride to form a solution having 4 molality sodium chloride (i.e., 4 moles of sodium chloride per kg of water, which is 65% saturation at 20° C.) and 0.2 mole percent (mol. %) sodium hydroxide based on moles of water present. The pH of Example 9 was 12.5.

### Example 10

Perform Example 10 using the same method as Example 6 except combine and stir enough potassium chloride and potassium hydroxide to form the composition of this solution having 4 molality potassium chloride (i.e., 4 moles of potassium chloride per kg of water, which is 87% saturation at 20° C.) and 1 mole percent (mol. %) potassium hydroxide based on moles of water present. The pH of Example 10 was 13.7.

### Example 11

Perform Example 11 using the same method as Example 6 except combine and stir enough potassium chloride and potassium hydroxide to form the composition of this solution having 4 molality potassium chloride in water (i.e., 4 moles of potassium chloride per kg of water, which is 87% saturation at 20° C.) and 0.2 mole percent (mol. %) potassium hydroxide based on moles of water present. The pH of Example 11 was 13.0.

### Example 12

Perform Example 12 using the same method as Example 6 except instead of adding POLYMER 1, add POLYMER 2 to the solution so as to provide a wellbore servicing fluid having 1 weight percent POLYMER 2 (based on the amount of water) and combine and stir enough potassium hydroxide with water and the potassium chloride to form a solution having 4 molality potassium chloride (i.e., 4 moles of potassium chloride per kg of water, which is 87% saturation at 20° C.) and 0.2 mole percent (mol. %) potassium hydroxide based on moles of water present. The pH of Example 12 was 13.0.

### Example 13

Perform Example 13 using the same method as Example 6 except instead of adding POLYMER 1, add POLYMER 2 to the solution so as to provide a wellbore servicing fluid having 1 weight percent POLYMER 2 (based on the amount of water) and combine and stir enough potassium hydroxide with water and the potassium chloride to form a solution having 4 molality potassium chloride (i.e., 4 moles of potassium chloride per kg of water, which is 87% saturation at 20° C.) and 1 mole percent (mol. %) potassium hydroxide based on moles of water present. Place 52 milliliters (mL) of the wellbore servicing fluid in the Grace Instrument M5600 HPHT rheometer. Pressurize the rheometer to 500 pounds per square inch (psi) and a temperature program is run as follows: Data collected every 60 seconds, shear rate=20 sec⁻¹, initial temperature=80° F. (27° C.) (hold 20 minutes), temperature ramp rate equals 1.3 degree ° F./minute, final temperature 320° F. (160° C.) (hold 3 minutes). The pH of Example 13 was 13.7.

### Example 14

Combine enough sodium hydroxide with water to form a solution having 1 mole percent (mol. %) sodium hydroxide based on moles of water present. Stir for 5-10 minutes to form a clear solution. Add POLYMER 1 to the solution so as to provide a solution having 1 weight percent POLYMER 1 (based on the amount water). Stir the solution for approximately 15 hours. Place 52 milliliters (mL) of the solution in the Chandler Engineering/Amtek Model 5550 HTHP viscometer. Pressurize the viscometer to 500 pounds per square inch (psi) and a temperature program is run as follows: Data collected every 60 seconds, shear rate=20 sec⁻¹, initial temperature=80° F. (27° C.) (hold 20 minutes), temperature ramp rate equals 1.3 degree ° F./minute, final temperature 320° F. (160° C.) (hold 3 minutes). The pH of Example 14 was 13.3.

### Example 15

Perform Example 15 using the same method as Example 14 except instead of sodium hydroxide, combine enough potassium hydroxide with water to form a solution having 1 mole percent (mol. %) potassium hydroxide based on moles of water present. Place 52 milliliters (mL) of the wellbore servicing fluid in the Grace Instrument M5600 HPHT rheometer. Pressurize the rheometer to 500 pounds per square inch (psi) and a temperature program is run as follows: Data collected every 60 seconds, shear rate=20 sec⁻¹, initial temperature=80° F. (27° C.) (hold 20 minutes), temperature ramp rate equals 1.3 degree ° F./minute, final temperature 320° F. (160° C.) (hold 3 minutes). The pH of Example 15 was 13.5.

### Example 16

Combine enough sodium hydroxide with water to form a solution having 1 mole percent (mol. %) sodium hydroxide based on moles of water present. Stir for 5-10 minutes to form a clear solution. Add POLYMER 2 to the solution to provide a solution having 1 weight percent POLYMER 2 (based on the amount water). Stir the solution for approximately 15 hours. Place milliliters (mL) of the solution in the Chandler Engineering/Amtek Model 5550 HTHP viscometer. Pressurize the viscometer to 500 pounds per square inch (psi) and a temperature program is run as follows: Data collected every 60 seconds, shear rate=20 see⁻¹, initial temperature=80° F. (27° C.) (hold 20 minutes), temperature ramp rate equals 1.3 degree ° F./minute, final temperature 320° F. (160° C.) (hold 3 minutes). The pH of Example 16 was 13.3.

### Example 17

Perform Example 17 using the same method as Example 16 except instead of sodium hydroxide, combine enough potassium hydroxide with water to form a solution having 1 mole percent (mol. %) potassium hydroxide based on moles of water present. Place 52 milliliters (mL) of the wellbore servicing fluid in the Grace Instrument M5600 HPHT rheometer. Pressurize the rheometer to 500 pounds per square inch (psi) and a temperature program is run as follows: Data collected every 60 seconds, shear rate=20 sec⁻¹, initial temperature=80° F. (27° C.) (hold 20 minutes), temperature ramp rate equals 1.3 degree ° F./minute, final temperature 320° F. (160° C.) (hold 3 minutes). The pH of Example 17 was 13.5.

### Comparative Examples G to L

Comparative Examples G and H are aqueous solutions of the POLYMER 1 and POLYMER 2, respectively (e.g., do not contain a base or a salt); Comparative Examples I and J are samples that include the salt (sodium chloride or potassium chloride), water and the POLYMER 1; and Comparative Examples K and L are samples that include the salt (sodium chloride or potassium chloride), water and the POLYMER 2. Comparative Examples G to L are prepared as follows.

### Comparative Example G

Add POLYMER 1 to water so as to provide a 1 weight percent POLYMER 1 (based on the amount water) solution. Stir the solution for approximately 15 hours. Place 52 milliliters (mL) of the solution in the Chandler Engineering/Amtek Model 5550 HTHP viscometer. Pressurize the viscometer to 500 pounds per square inch (psi) and a temperature program is run as follows: Data collected every 60 seconds, shear rate=20 sec⁻¹, initial temperature=80° F. (27° C.) (hold 20 minutes), temperature ramp rate equals 1.3 degree ° F./minute, final temperature 320° F. (160° C.) (hold 3 minutes). The pH of Comparative Example G was 7.0.

### Comparative Example H

Perform Comparative Example H using the same method as Comparative Example G except instead of adding POLYMER 1, add POLYMER 2 to water so as to provide a 1 weight percent POLYMER 2 (based on the amount water) solution. The pH of Comparative Example H was 8.4.

### Comparative Example I

Combine enough sodium chloride with water to form a solution having 4 molality sodium chloride (i.e., 4 moles of sodium chloride per kg of water). Stir for 5-10 minutes to form a clear solution. Add POLYMER 1 to the solution so as to provide a solution having 1 weight percent POLYMER 1 (based on the amount water). Stir the solution for approximately 15 hours. Place 52 milliliters (mL) of the solution in the Chandler Engineering/Amtck Model 5550 HTHP viscometer. Pressurize the viscometer to 500 pounds per square inch (psi) and a temperature program is run as follows: Data collected every 60 seconds, shear rate=20 see⁻¹, initial temperature=80° F. (27° C.) (hold 20 minutes), temperature ramp rate equals 1.3 degree ° F./minute, final temperature 320° F. (160° C.) (hold 3 minutes). The pH of Comparative Example I was 7.2.

### Comparative Example J

Perform Comparative Example J using the same method as Comparative Example I except instead of sodium chloride, combine enough potassium chloride with water to form a solution having 4 molality potassium chloride (i.e., 4 moles of potassium chloride per kg of water). Place milliliters (mL) of the wellbore servicing fluid in the Grace Instrument M5600 HPHT rheometer. Pressurize the rheometer to 500 pounds per square inch (psi) and a temperature program is run as follows: Data collected every 60 seconds, shear rate=20 sec⁻¹, initial temperature=80° F. (27° C.) (hold 20 minutes), temperature ramp rate equals 1.3 degree ° F./minute, final temperature 320° F. (160° C.) (hold 3 minutes). The pH of Comparative Example J was 6.0.

### Comparative Example K

Perform Comparative Example K using the same method as Comparative Example I except instead of adding POLYMER 1, add POLYMER 2 to the solution so as to provide a solution having 1 weight percent POLYMER 2 (based on the amount water). Place 52 milliliters (mL) of the wellbore servicing fluid in the Grace Instrument M5600 HPHT rheometer. Pressurize the rheometer to 500 pounds per square inch (psi) and a temperature program is run as follows: Data collected every 60 seconds, shear rate=20 sec⁻¹, initial temperature=80° F. (27° C.) (hold 20 minutes), temperature ramp rate equals 1.3 degree ° F./minute, final temperature 320° F. (160° C.) (hold 3 minutes). The pH of Comparative Example K was 6.7.

### Comparative Example L

Perform Comparative Example L using the same method as Comparative Example I except instead of adding POLYMER 1, add POLYMER 2 to the solution so as to provide a solution having 1 weight percent POLYMER 2 (based on the amount water) and instead of sodium chloride, combine enough potassium chloride with water to form a solution having 4 molality potassium chloride (i.e., 4 moles of potassium chloride per kg of water). Place 52 milliliters (mL) of the wellbore servicing fluid in the Grace Instrument M5600 HPHT rheometer. Pressurize the rheometer to 500 pounds per square inch (psi) and a temperature program is run as follows: Data collected every 60 seconds, shear rate=20 sec⁻¹, initial temperature=80° F. (27° C.) (hold 20 minutes), temperature ramp rate equals 1.3 degree ° F./minute, final temperature 320° F. (160° C.) (hold 3 minutes). The pH of Comparative Example L was 6.6.

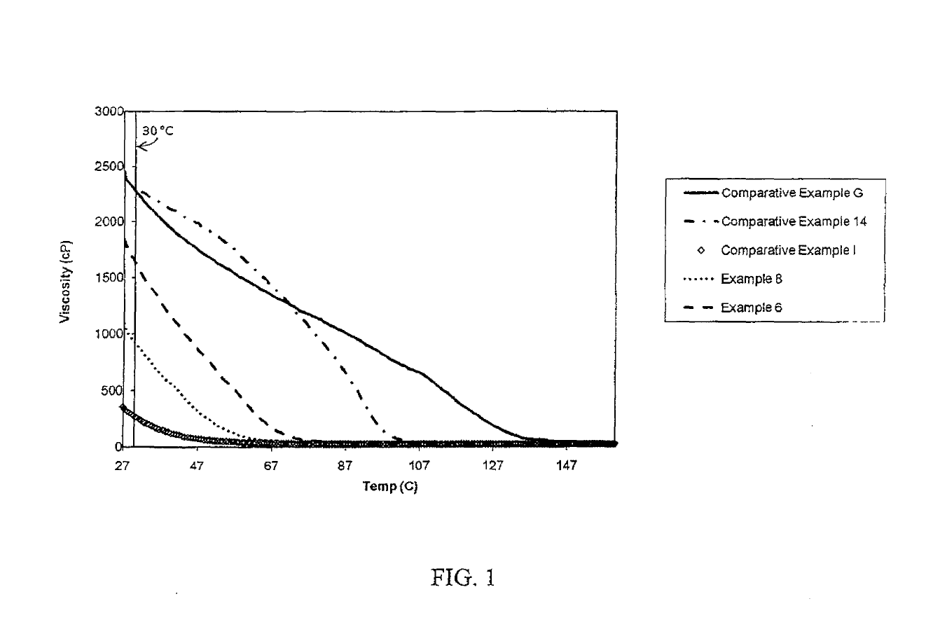

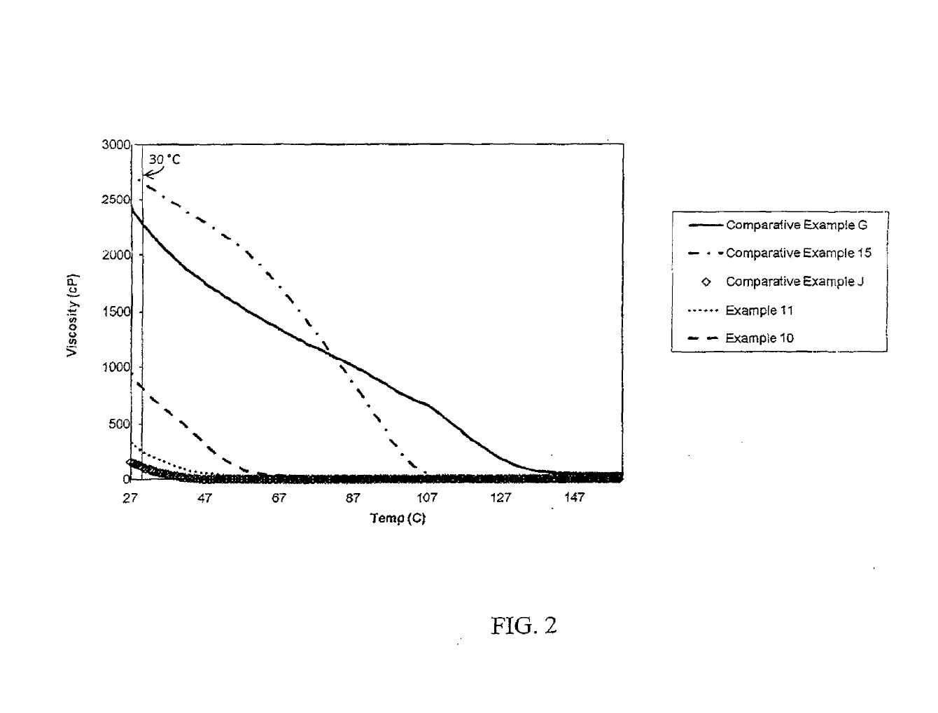

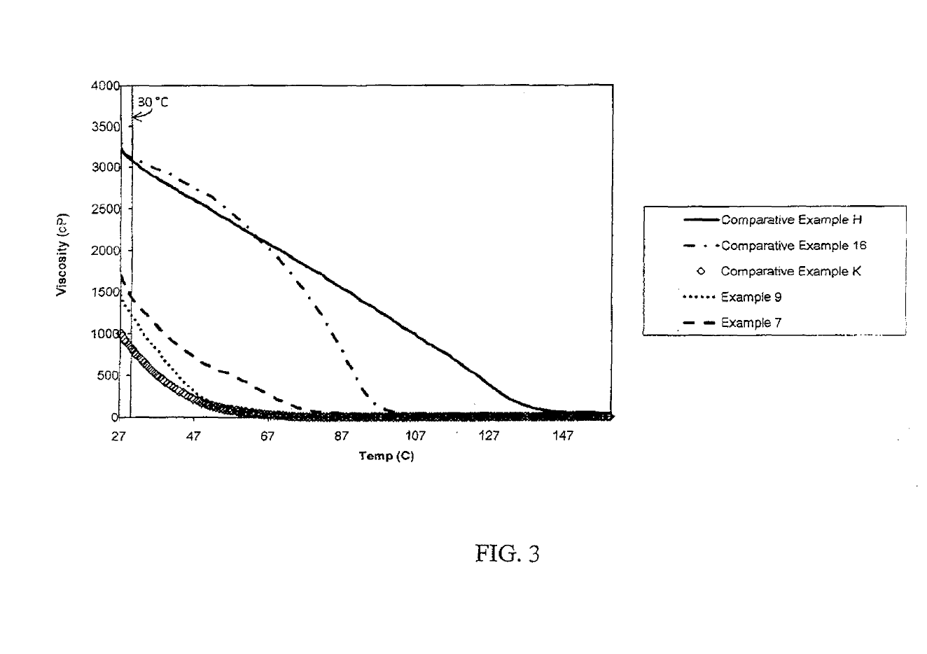

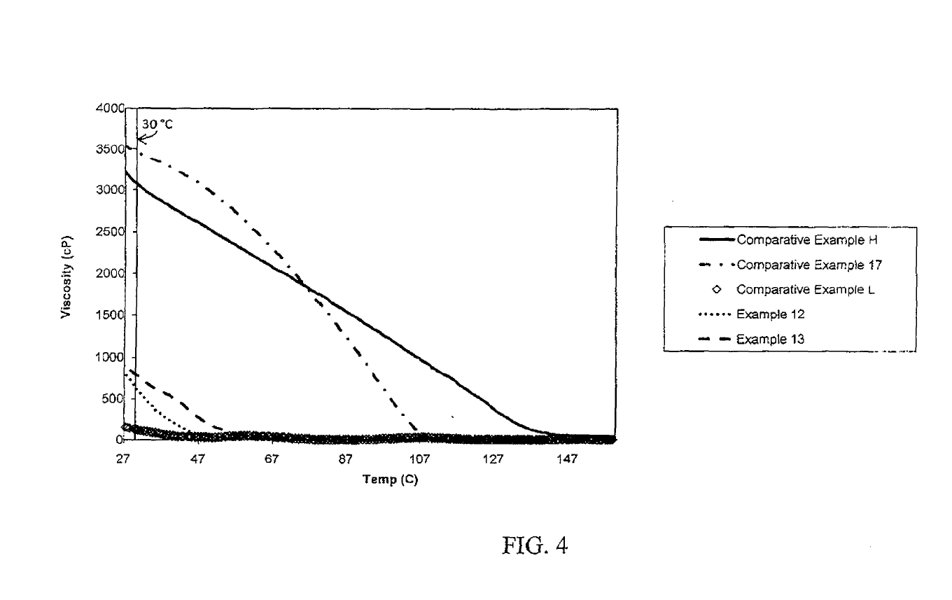

Results for Examples 6 through 17 and Comparative Examples (Corn. Ex.) G through L are provided in FIGS. 1 through 4. FIG. 1 provides viscosity versus temperature results of Examples 6, 8 and 14, and Comparative Examples G and I, all of which include water with POLYMER 1 and either sodium chloride, sodium hydroxide, both sodium chloride and sodium hydroxide, or neither base nor salt (e.g., just water with POLYMER 1). FIG. 2 provides viscosity versus temperature results of Examples 10, 11 and 15, and Comparative Examples G and J, all of which include water with POLYMER 1 and either potassium chloride, potassium hydroxide, both potassium chloride and potassium hydroxide or neither base nor salt (e.g., just water with POLYMER 1). FIG. 3 provides viscosity versus temperature results of Examples 7, 9 and 16 and Comparative Examples H and K, all of which include water with POLYMER 2 and either sodium chloride, sodium hydroxide, both sodium chloride and sodium hydroxide or is left neat (e.g., just water with POLYMER 2). Finally, FIG. 4 provides viscosity versus temperature results of Examples 12, 13 and 17 and Comparative Examples H and L, all of which include water with POLYMER 2 and either potassium chloride, potassium hydroxide, both potassium chloride and potassium hydroxide or neither base nor salt (e.g., just water with POLYMER 2).

As illustrated in FIGS. 1-4, each of the hydrophobically modified polymers in water (Comparative Examples G and H in each of FIGS. 1-4) showed a decrease in viscosity with an increase in temperature. Examples 14 through 17 show an improvement in the viscosity at lower relative temperatures, but with a more rapid drop of viscosity as the temperature increases relative to the hydrophobically modified polymers in water (Comparative Examples G and H).

FIGS. 1 through 4 also demonstrate that the addition of salt to the hydrophobically modified polymers in water (Comparative Examples I through L) causes a significant, if not precipitous, drop in the viscosity. In contrast, Examples 6 through 13 demonstrate that the wellbore servicing fluid of the present disclosure can minimize what would have been the significant change in viscosity seen in Comparative Examples G through K. Examples 6 through also illustrate that higher relative pH values for the wellbore servicing fluid help to better retain viscosity values upon the addition of the salt.

As provided herein, the viscosity values measured from Examples 6-17 and Comparative Examples G-L (the bench top approach discussed above in the detailed description) can be used to help quantify the ability of the wellbore servicing fluid to minimize changes in the viscosity relative a control solution. For these examples, the control solution (defined as the diluent and the hydrophobically modified polymer) without salt includes Comparative Examples G and H; the control solution with salt includes Comparative Examples I, J, K and L; the wellbore servicing fluid without salt includes Examples 14 through 17 and the wellbore servicing fluid with salt includes Examples 6 through 13.

The predefined salt concentration for NaOH used in Examples 6 through 9 and Comparative examples I and K is 65% of saturation for NaCl and 80% of saturation for KCl at 30° C. The predefined salt concentration for KOH used in Examples 10 through 13 and Comparative examples J and L is 65% of saturation for NaCl and 80% of saturation for KCl at 30° C.

Taking viscosity values from FIGS. 1-4 at a predetermined temperature of 30° C., the ratio of the relative change in viscosity for each of the wellbore servicing fluid and the control solution can be calculated. Other viscosity values for different predetermined temperatures can also be taken from FIGS. 1-4. Table III provides the viscosity values read from FIGS. 1-4 at the predetermined temperature of 30° C. These values are used in calculating the relative change in viscosity for each of the wellbore servicing fluid and the control solution at 30° C.

TABLE III

| | | Viscosity/cP at 30° C. | | | |
|---|---|---|---|---|---|
| System | | WSF | WSF | CS | CS |
| Polymer | Salt/Base | w/o salt | w/salt | w/o salt | w/salt |
| Polymer 1 | NaCl/NaOH | 2287 | 1631 | 2255 | 270 |
| Polymer 2 | NaCl/NaOH | 3097 | 1440 | 3060 | 824 |
| Polymer 1 | KCl/KOH | 2667 | 816 | 2255 | 108 |
| Polymer 2 | KCl/KOH | 3460 | 790 | 3060 | 122 |

The relative change in viscosity can be calculated as follows:

$$Relative change in viscosity = \frac{( WSF without salt ) - ( WSF with salt )}{( CS without salt ) - ( CS with salt )}$$

For the predetermined temperature of 30° C., the relative change in viscosity for Example 14 (WSF without salt, POLYMER 1, with NaOH for apH=13.3) relative Example 6 (WSF with salt (NaCl, 65% saturation), POLYMER 1, with NaOH for a pH=13.0 and) is a value of less than 0.33. For the predetermined temperature of 30° C., the relative change in viscosity for Example 15 (WSF without salt, POLYMER 1, with KOH for a pH=13.5) relative Example 10 (WSF with salt (KCl, 80% saturation), POLYMER 1, with KOH for apH=13.7) is a value of less than 0.86. For the predetermined temperature of 30° C. the relative change in viscosity for Example 16 (WSF without salt, POLYMER 2, with NaOH for a pH=13.5) relative Example 7 (WSF with salt (NaCl, 65% saturation), POLYMER 2, with NaOH for a pH=13.0) is a value of less than 0.74. For the predetermined temperature of 30° C., the relative change in viscosity for Example 17 (WSF without salt, POLYMER 2 with KOH for a pH=13.3) relative Example 13 (WSF with salt (KCl, 80% saturation), POLYMER 1, with KOH for a pH=13.7) is a value of less than 0.91.

It is to be understood that the above description has been made in an illustrative fashion, and not a restrictive one. Although specific embodiments have been illustrated and described herein, those of ordinary skill in the art will appreciate that other component arrangements can be substituted for the specific embodiments shown. The claims are intended to cover such adaptations or variations of various embodiments of the disclosure, except to the extent limited by the prior art.

In the foregoing Detailed Description, various features are grouped together in exemplary embodiments for the purpose of streamlining the disclosure. This method of disclosure is not to be as interpreted as reflecting an intention that any claim requires more features than are expressly recited in the claim. The following claims are hereby incorporated into the Detailed Description, with each claim standing on its own as a separate embodiment of the disclosure.

1. A wellbore servicing fluid, comprising:
a diluent;
a hydrophobically modified polymer; and
an amount of a base, where the amount of the base adjusts a pH of the wellbore servicing fluid to greater than 10 thereby providing a viscosity that decreases no more than 33 percent of a change of viscosity in a control solution measured at 30° C., when a predefined concentration of salt is present in each of the control solution and the wellbore servicing fluid.

2. The wellbore servicing fluid of claim 1, where the amount of the base adjusts the pH of the wellbore servicing fluid to greater than 10 thereby providing a viscosity that decreases no more than 74 percent of a change of viscosity in a control solution defined as the diluent and the hydrophobically modified polymer, measured at 30° C., when a predefined concentration of salt is present in each of the control solution and the wellbore servicing fluid.

3. The wellbore servicing fluid of claim 1, where the hydrophobically modified polymer is a hydrophobically modified polysaccharide.

4. The wellbore servicing fluid of claim 3, where the hydrophobically modified polysaccharide is a hydrophobically modified hydroxyethyl cellulose.

5. The wellbore servicing fluid of claim 4, where an ethylene oxide molar substitution of the hydrophobically modified hydroxyethyl cellulose is from 0.5 to 3.5.

6. The wellbore servicing fluid of claim 4, where a hydrophobe degree of substitution of the hydrophobically modified hydroxyethyl cellulose is from 0.001 to 0.025.

7. The wellbore servicing fluid of claim 1, where a weight-average molecular weight of the hydrophobically modified polymer is from 500,000 to 4,000,000 Daltons.

8. The wellbore servicing fluid of claim 1, where the predefined concentration of salt is more than fifty percent of the saturation concentration.

9. The wellbore servicing fluid of claim 1, where the salt includes a monovalent salt.

10. The wellbore servicing fluid of claim 1, where the amount of the base adjusts the pH of the wellbore servicing fluid to at least 11.

11. A method of minimizing a change in a viscosity of a wellbore servicing fluid when a salt mixes with the wellbore servicing fluid, the method comprising:
providing an admixture of a diluent and a hydrophobically modified polymer; and
adding a base to the admixture to adjust a pH of the wellbore servicing fluid to greater than 10 to provide a viscosity of the wellbore servicing fluid sufficient to maintain drilling operations when the salt is present in the wellbore servicing fluid.

12. The method of claim 11, where adding the base provides the wellbore servicing fluid with the viscosity, measured at 30° C., which decreases no more than 33 percent of a change of viscosity in a control solution, measured at 30° C., when a predefined concentration of the salt is present in each of the control solution and the wellbore servicing fluid.

13. The method of claim 11, where the salt is present in the wellbore servicing fluid at a concentration of more than fifty percent of the saturation concentration.

14. The method of claim 11, where the pH is adjusted to at least 11.

15. The method of claim 11, where adding the base includes adjusting the pH of the wellbore servicing fluid containing the salt to a value of greater than 10 to increase the viscosity of the wellbore servicing fluid to a value greater than the viscosity at the pH of 10.
